(19) United States
(12) Patent Application Publication
(10) Pub. No.: US 2005/0005488 A1
(43) Pub. Date: Jan. 13, 2005

(54) Motor vehicle decal display system

(76) Inventor: Malcolm Anton McManus Burke, Washington, DC (US)

Correspondence Address: Malcolm A. Burke, PO BOX 3538, Washington, DC, 20027, US

(21) Appl. No.: 10/615,066

(22) Filed: Jul. 9, 2003

(51) Int. Cl. G09F 21/04

(52) U.S. Cl. 40/591

(57) ABSTRACT

The present invention provides a method and means for activating and controlling the display of decals, stickers, labels, placards, automatic toll paying devices, or similar items through the use of actuating decal plates that may be programmed to be exposed dependent on a motor vehicle's operating status, or at the discretion of the motor vehicle operator. The motor vehicle decal display system will comprise single or multiple decal display plates, decal display plate housing(s), and button(s), switch(es) or other means of manual or sensate activation, whereby decals may be displayed depending on the nature of the vehicles operation, or the commands of the operator.

### CROSS REFERENCE TO RELATED APPLICATIONS

NOT APPLICABLE

### STATEMENT REGARDING FEDERALLY SPONSORED RESEARCH OR DEVELOPMENT

NOT APPLICABLE

### REFERENCE TO SEQUENCE LISTING, ETC.

NOT APPLICABLE

### BACKGROUND OF THE INVENTION

The present invention relates to a method and means of displaying decals, stickers, labels, placards, automatic toll paying devices, or other like items so they are visible through the windows of a motor vehicle. More particularly, the present invention relates to an apparatus and means of activating and controlling the the display of said decals, stickers, placards, or similar items so that they may be exposed when the car is parked, and removed from view when the motor vehicle is being operated, vice-versa, or so that the display of said decals, stickers, labels, placards, or similar items may be made at the motor vehicle operator's discretion. Additionally, the present invention will allow for the easy removal and/or replacement of said decals, stickers, labels, placards, or similar items, by means of removable decal plates.

It is common for federal, state, municipal, and local governments, as well as clubs, residential associations, private beaches, parking lots, schools, businesses, or other organizations to require the display of certain decals, stickers, labels, placards, or similar items in the windows of motor vehicles, particularly automobiles, to indicate the particular automobile owner or operator's compliance with registration, inspection, residency, membership, affiliation, enrollment, or other obligations, or to otherwise indiacte the particualr status of the motor vehicle or the owner or operator thereof pertinent to the particular authority or organization. Present means and methods of displaying these decals, stickers, labels, placards, or similar items, provides that the decals, stickers, labels, placards, or similar items be affixed or placed directly on the interior or exterior surface of the windshield glass, or the glass of certain other windows of the motor vehicle, or to the forward-facing portion of the rear view mirror.

There are inherent disadvantages to a means and method of decal, sticker, label, placard, or similar item display that does not allow for exposure of said decals, stickers, labels, placards, or similar items at the discretion of the motor vehicle operator, or automatically, given the particular nature of the motor vehicle's operation. Specifically, the prior art creates a situation in which the operator of a motor vehicle, upon the windows of which have been affixed or placed certain decals, stickers, labels, placards, or similar items, has a reduced field of vision through said windows. As a particular motor vehicle may have multiple decals, stickers, labels, placards, or similar items affixed or displayed to its windows, the field of vision of that motor vehicle's operator may be significantly compromised. This compromised field of vision may or may not have been accounted for by the designer of said motor vehicle, and jeoprardizes the operator's ability to operate the motor vehicle in the safest manner possible. Moreover, by not being able to direct the display of certain decals, stickers, labels, placards, or similar items, the motor vehicle operator may be disclosing information to passersby that he or she would rather keep confidential, and if affixed to the exterior of a motor vehicle's window the decal, sticker, label, placard, or similar items is vulnerable to theft or mutilation. Additionally, as time passes and replacement decals are issued bt various authorities or organizations, it becomes necessary to remove and/or replace the decals, stickers, labels, placards, or similar items affixed to the windows. At times this may be very difficult due to the awkward positioning of the decals, stickers, labels, placards, or similar items, as well as to the condition of the adhesive which affixed the decal, as it has been effected by sunlight and other elementrs effecting the window. Finally, the prior art creates a situation where the operator of a motor vehicle cannot transfer decals, stickers, labels, placards, or similar items which have been affixed to a window from one motor vehicle to another. (For example, in cases where a motor vehicle must be repaired, and the operator uses another, temporarry motor vehicle, it would be advantageous to transfer a parking decal to the temporary motor vehicle.) It is to these failures of the prior art to which the present invention is drawn.

### BRIEF SUMMARY OF THE INVENTION

The present invention provides a system for activating, controlling, and replacing, the display of decals, stickers, labels, placards, or similar items through the windows of a motor vehicle. The motor vehicle decal display system will comprise a single, or multiple decal display plates (herinafter, “decal plates”) upon which decals, stickers, labels, placards, or similar items may be placed. One or more of these decal plates may be designed to accept an automatic toll-paying device. The location of these decal plates will be in those areas of the windows of a motor vehicle which have traditionally been used to display decals, stickers, labels, placards, or similar items (e.g.: the edges of the front windshield, particularly the corners therof; the edges of the rear window, particularly the corners thereof; the forward-facing surface of the rear view mirror; and such other places as may be deemed appropriate for display of decals, stickers, labels, placards, or similar items). These decal plates may be retracted into that space between the interior and exterior body panels of the motor vehicle, thereby concealing display of any decals affixed thereto. The motor vehicle decal display system will also comprise a single or multiple switches, buttons or other means of manual or sensate activation, whereby the position of the decal plates (either exposed or retracted) can be adjusted and thereby the display of certain decals, stickers, labels, placards, or similar items through the windows of a motor vehicle may be engaged as directed by the operator, or may be programmed to be displayed automatically given the particular nature of the vehicle's operation. Additionally, the motor vehicle decal display system will comprise a means of removing and/or replacing the decal plates, to allow for easier removal of the decals affixed thereto, or for the replacement or transfer of the decal plate altogether.

The switch or other means of activation and the circuitry connected thereto will allow for the programming of a particular decal plate in a multitude of ways, including: 1) to always be retracted during operation of the motor vehicle, while automatically being exposed while the motor vehicle is engaged in the “parked” gear, or in some other nature or manner of operation, and 2), to always be retracted while the motor vehicle is engaged in the “parked” gear, or in some other nature or manner of operation and automatically exposed during operation of the motor vehicle. The advantage to this invention is that it allows for the display of certain decals, stickers, labels, placards, or similar items through the windows of a motor vehicle, only when the viewing thereof is possible, warranted, or desired by the operator, and thereby the operator's field of vision through the windows of the motor vehicle will not be needlessly impaired.

The switch or other means of activation of the decal plate may also be activated automatically by outside influnces on the motor vehicle. For example, when the motor vehicle approches a parking garage for which it has a parking pass or decal, a transmitter at the garage may activate the decal plate that contains the parking pass, and thereby expose the parking pass. Similar activation from the exterior of the motor vehicle would be advantageous for use of automatic toll-paying devices such as “SpeedPass” and “EZPass” in conjunction with the present invention.

Previously, the operator of a motor vehicle could not manage the display of decals, stickers, labels, placards, or similar items, as described above. The present invention allows for this management, makes operation of the motor vehicle safer, limits discosure of certain informtaion, and makes replacement/removal of decals, stickers, labels, placards, or similar items easier.

### BRIEF DESCRIPTION OF THE SEVERAL VIEWS OF THE DRAWING

Not Applicable

### DETAILED DESCRIPTION OF THE INVENTION

The present means and methods of displaying decals, stickers, labels, placards, or similar items, provides that the decals, stickers, labels, placards, or similar items be affixed or placed directly on the interior or exterior surface of the windshield glass, or the glass of certain other windows of the motor vehicle, or to the forward-facing portion of the rear view mirror. This produces the inadequacy of impairing the motor vehicle operator's view, needlessly disclosing personal information, and making removal of the decals difficult. This invention will consist of a button, switch, or other means of sensate activation, and the cicuitry to control automatically, the activation and exposure of the decal plates in a manner consistent with the operator's discretion. Developed as a multitude of decal plates this invention is an improvement to the areas immediatetly surrounding the windshield and other windows of the motor vehicle.

The best mode of design and composition for the individual decal plates is that of a clear plastic or safety glass plate, of minimal thickness measuring approximately six (5) inches by four (4) inches with a decal display areas of approximately five (5) inches by three (3) inches. With multiple display plates loacted at the the perimeter of the windshield, the operator can display decals at particulatr locations, as presecribed by the pertinent authorities, or issuers of the decals, as the case may be. (For example, in Washington D.C., motor vehicle operators are directed to place their vehicle registration decal in the lower left-hand corner of the driver's side of the windshield.) Further, when exposed or extended from the decal plate housing (described below), the decal plates would be oriented in such a manner as prevent their vibration against, or contact with, the motor vehicle's window.

The best mode of design of the decal plate housing(s) is for the placement thereof between the exterior and interior body panels of the motor vehicle with a non-obtrusive and discrete appearance. The decal plate would be housed within this decal plate housing recessed between the interior and exterior body panels of the motor vehicle. (For example, between the exterior roof panel of the motor vehicle and the interior ceiling panel of the motor vehicle for the display of decals in the upper-right corner; upper-center; and/or upper-left corner of the forward windshield.) Within each housing could be stacked several decal plates, to allow for the display of different decals which need not need to be displayed simultaneously, or a single decal plate. The mechanism by which the selected decal plates may be retracted or exposed may consist of a pair of rails or tracks along the interior edge of the decal plate housing, within which the decal plate is seated. When activated, the decal plates are exposed by a spring loaded mechanism, or by activation of an electrical motor or device that pushes the decal plate from the housing. This is most easily performed by connecting the decal plate housing, and the device that exposes the decal plate to the vehicle's electrical power supply. Additionally, the housing provides for manual over-ride operation, through the inclusion of a small opening in the housing and the interior body panel of the motor vehicle, in which could be placed an article, like a pen or key to push the decal plate along the tracks, and thereby expose or retract the decal plate. Finally, the housing provides a means of removing, and replacing decal plates. This is readily accomplished by the inclusion of a removable facing around the opening through which the decal plate passes that would allow for the full length of the plate to be exposed and removed from the above described rails, or tracks.

While the invention has been described with particular reference to a best mode, it will be understood by those skilled in the art that various changes may be made and equivalents may be substituted for elements of the best mode without departing from the invention. For example, many modifications may be made to adapt a particular situation and material to a teaching of the invention without departing from the essential teachings of the present invention.

As is evident from the foregoing description, certain aspects of the invention are not limited to the particular details of the examples illustrated, and it is therefore contemplated that other modifications and applications will occur to those skilled the art. For example, items other than decals, stickers, labels, placards, and toll paying devices may affixed to the decal plates. Also, the exact means of activation and operation of the decal plates may be accomplished in a multitude of ways. It is accordingly intended that the claims shall cover all such modifications and applications as do not depart from the true spirit and scope of the invention.

1. A decal display unit or system within a motor vehicle comprising:
a plurality of decal display plates;
a means for extending or exposing said decal display plates from within a housing unit (an “extender”) comprising a first selector switch associated with said extender wherein said first selector switch is adapted to extend the decal display plate when the motor vehicle is in the “park” gear by activating the extender; and
a second selector switch associated with said extender wherein said second selector switch is adapted to extend the decal display plate when the motor vehicle is in an “operating” gear by activating the extender; and
a decal display plate housing sandwiched between the interior and exterior body panels of the motor vehicle in proximity to the windshield or other motor vehicle window.

2. The decal display unit or system as in claim 1, wherein said means of operation of said extender include a manual override slot.

3. The decal display unit or system as in claim 1, wherein said decal display plate housing further comprises:
a means of removing a decal display plate from said housing.
